(19) United States
(12) Patent Application Publication
(10) Pub. No.: US 2005/0212291 A1
(43) Pub. Date: Sep. 29, 2005

(54) Sanitary gasket

(76) Inventor: Simon P. Edwards, Irvine, CA (US)

Correspondence Address: King & Jovanovic, PLC, 170 College Avenue, SUITE 230, HOLLAND, MI, 49423, US

(21) Appl. No.: 10/812,344

(22) Filed: Mar. 29, 2004

(51) Int. Cl. F16L 17/00

(52) U.S. Cl. 285/364

(57) ABSTRACT

A sanitary gasket for use between two pipes, each having a ferrule face defining a channel thereon. The sanitary gasket comprises a spacing assembly and a gasket assembly. The spacing assembly, having a spacing member including a body having an inner edge and an outer edge. The gasket assembly having a spacing assembly interfacing edge associated with the inner edge of the spacing assembly. The gasket assembly is of a softer material than the spacing assembly, such that, upon clamping, the spacing assembly controls the spacing between two pipes, and, in turn, the compression of the gasket assembly.

### BACKGROUND OF THE INVENTION

1. Field of the Invention

The present invention relates in general to gaskets, and, in particular, to a sanitary gasket which overcomes many of the deficiencies with conventional sanitary gaskets often utilized in the fluid transport industry, for example, in association with the food processing industry.

2. Background Art

Gaskets are commonplace in the fluid transport industry, such as the food processing industry. Such gaskets are utilized in combination with fittings and clamps to join lengths of pipes, storage tanks and valves for the filling of, for example, liquid into containers. One commonly used gasket is referred to as the “Tri-Clamp” sold by Tri-Clover, Inc. A cross-sectional portion of one such gasket 200 is shown in FIG. 1, between two pipes 202, 212. The gasket comprises a substantially uniform material which is substantially planar and includes opposing annular ribs. The opposing ribs engage grooves on opposing lengths of pipe, such that the gasket is properly positioned for clamping. Once engaged, a clamp is positioned over the pipe to sandwich the gasket between the two pipes.

Inasmuch as the gasket must preclude leaking between the sections of pipe, the gasket must be made from a substantially flexible material which can accomplish such a task. Due to the flexibility of the gasket material, the system is prone to problems.

One such problem is that the material is too flexible to control the compression of the gasket. Without control of the compression, the clamp is prone to over-tightening. As a result of over-tightening, the gasket material is extruded into the bore of the pipe. Such a situation is shown in FIG. 2. In such a situation, the gasket becomes an impediment to flow, and a possible collection point for debris and microbial growth. Additionally, such extrusion of the gasket material leads to failure of the seal and the leakage of the material. Moreover, as gasket temperatures change (often occurring during cleaning and sanitizing of a filling system), the gasket size tends to change and the clamp can become loose. Such a situation can cause a catastrophic failure at the gasket.

Certain solutions have become available which provide some guidance relative to the proper tightening of a clamp to join pipes about a gasket. Certain of such solutions are shown in FIGS. 3 and 4. In particular, the opposing pipes abut at abutment region 220 to control compression of the gasket. While these solutions represent an advancement over the prior designs, they are likewise problematic. For example, the gaskets require special pipes with special ferrules having ferrule faces 204, 214 in order to properly accomplish the necessary tasks. Moreover, the gasket of FIG. 3 can extrude into the abutment region 220 thereby precluding abutment of opposing pipes, which, in turn, may lead to leaking.

Accordingly, it is an object of the invention to provide a gasket which is capable of controlling tightening of the assembly, to, in turn, preclude inadvertent over or under-tightening situations.

It is another object of the invention to provide a gasket which is capable of controlling tightening of the assembly while cooperating with standard pipes having standard ferrules.

It is a further object of the invention to provide a gasket which minimizes intrusion into the bore of the pipes.

These and other objects will become apparent in light of the specification and claims appended hereto.

### SUMMARY OF THE INVENTION

The invention comprises a sanitary gasket for use between two pipes, each having a ferrule face defining a channel thereon. The sanitary gasket comprises a spacing assembly and a gasket assembly. The spacing assembly includes a spacing member including a body having an inner edge and an outer edge. The gasket assembly includes a spacing assembly interfacing edge associated with the inner edge of the spacing assembly. The gasket assembly is of a softer material than the spacing assembly, such that, upon clamping, the spacing assembly controls the spacing between two pipes, and, in turn, the compression of the gasket assembly.

In a preferred embodiment, the spacing assembly further comprises a positioning member associated with the outer edge thereof. The positioning member has at least one ferrule engaging member. In one such preferred embodiment, the at least one ferrule engaging member extends outwardly from one of a bottom surface and a top surface of the spacing member. In one such embodiment, the at least one ferrule engaging member extends outwardly from each of the bottom surface and the top surface of the spacing member.

In yet another preferred embodiment, the at least one ferrule engaging member comprises a plurality of discrete ferrule engaging member positioned about the outer edge of the spacing member. Preferably, the at least one ferrule engaging member extends continuously about the outer edge of the spacing member.

In yet another preferred embodiment, the spacing assembly interfacing edge is spaced apart from the inner edge of the spacing assembly.

In another preferred embodiment, the spacing assembly interfacing edge is mechanically attached to the inner edge of the spacing assembly.

In another preferred embodiment, the spacing assembly interfacing edge and the inner edge of the spacing assembly are one of adhered and co-molded together.

In yet another preferred embodiment, the spacing assembly interfacing edge and the inner edge of the spacing assembly overlap.

In a preferred embodiment, the gasket assembly further includes a pair of opposing ribs which are configured so as to interface with an opposing channel in each of two pipes.

In a preferred embodiment, the gasket assembly may include at least one opening extending therethrough, to, in turn, provide for leak detection.

In another aspect of the invention, the invention comprises a combination pipe and gasket. The combination comprises a first pipe, a second pipe and a sanitary gasket. The first pipe includes a ferrule face defining a channel thereon. The second pipe has a ferrule face defining a channel thereon. The ferrule faces of the first and second pipe, as well as the channels of the first and second pipes substantially correspond to each other. The sanitary gasket is positioned between the two pipes. The sanitary gasket comprises a spacing assembly and a gasket assembly. The spacing assembly includes a spacing member including a body having an inner edge and an outer edge. The gasket assembly includes a spacing assembly interfacing edge associated with the inner edge of the spacing assembly. The gasket assembly is of a softer material than the spacing assembly, such that, upon clamping, the spacing assembly controls the spacing between two pipes, and, in turn, the compression of the gasket assembly.

In another aspect of the invention, the invention comprises a sanitary gasket for use between two pipes, each having a ferrule face defining a channel thereon. The sanitary gasket comprising a spacing assembly and a gasket assembly. The spacing assembly has a spacing member including a body having an inner edge, an outer edge, a top surface and a bottom surface. The gasket assembly has a spacing assembly interfacing edge, a bore interfacing edge, a top surface and a bottom surface. Each of the top surface and the bottom surface including opposing ribs positioned thereon. The spacing assembly interfacing edge is associated with the inner edge of the spacing assembly. The gasket assembly is of a softer material than the spacing assembly, such that, upon clamping, the spacing assembly controls the spacing between two pipes, and, in turn, the compression of the gasket assembly.

In a preferred embodiment, the spacing assembly and the gasket assembly are integrated into a single component.

In another embodiment of the invention, the sanitary gasket includes a gasket assembly and a spacing assembly. The gasket assembly includes a bore interfacing edge, a top surface and a bottom surface. Each of the top surface and the bottom surface including opposing ribs positioned thereon. The spacing assembly comprises a plurality of plugs disposed about the gasket assembly. Each of the plurality of plugs having a top surface and a bottom surface. The gasket assembly is of a softer material than the spacing assembly, such that, upon clamping, the spacing assembly controls the spacing between two pipes, and, in turn, the compression of the gasket assembly.

In one embodiment the plurality of plugs are fully surrounded by the gasket assembly.

In another embodiment, the plurality of plugs are positioned at a predetermined distance from the bore interfacing edge of the gasket assembly.

In yet another preferred embodiment, the plurality of plugs are substantially circular in shape.

### BRIEF DESCRIPTION OF THE DRAWINGS

The invention will now be described with reference to the drawings wherein:

FIG. 1 of the drawings comprises a partial cross-sectional view of a prior art gasket positioned between two pipes, in a clamped position (with the clamp not shown);

FIG. 2 of the drawings comprises a partial cross-sectional view of a prior art gasket positioned between two pipes, in a clamped position (with the clamp not shown);

FIG. 3 of the drawings comprises a partial cross-sectional view of a prior art gasket positioned between two pipes, in a clamped position (with the clamp not shown);

FIG. 4 of the drawings comprises a partial cross-sectional view of a prior art gasket positioned between two pipes, in a clamped position (with the clamp not shown);

FIG. 5 of the drawings comprises a partial perspective view of a sanitary gasket of the present invention;

FIGS. 6a-6h of drawings comprises a partial cross-sectional view of a plurality of different sanitary gasket configurations of the present invention;

FIG. 7 of the drawings comprises a perspective view of opposing ferrules showing the clamp therebetween;

FIG. 8 of the drawings comprises a cross-sectional perspective view of the device shown in FIG. 7, taken generally about lines 8-8 of FIG. 7; and

FIG. 9 of the drawings comprises a perspective view of a sanitary gasket of the present invention, showing the plurality of openings for detecting a leak.

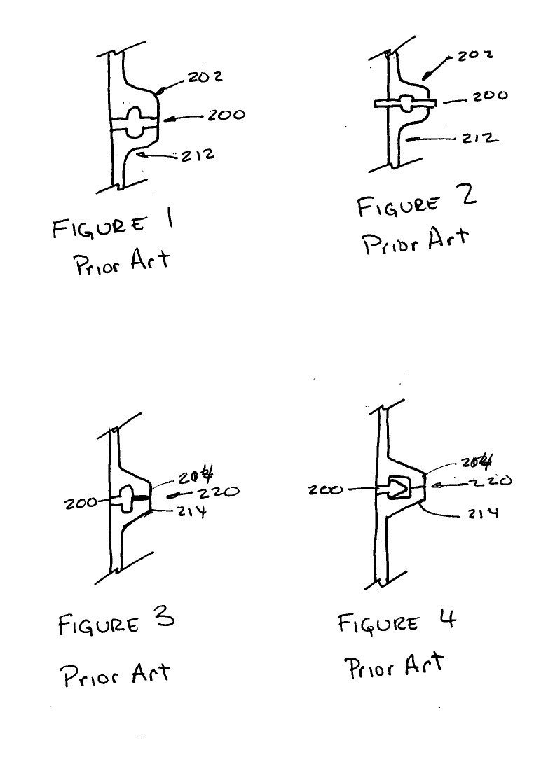

### DETAILED DESCRIPTION OF THE INVENTION

While this invention is susceptible of embodiment in many different forms, there is shown in the drawings several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

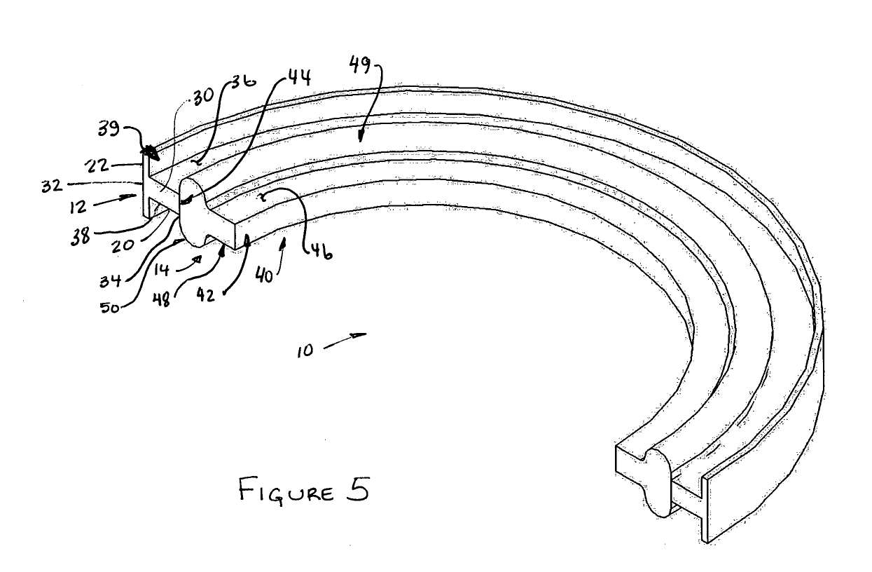

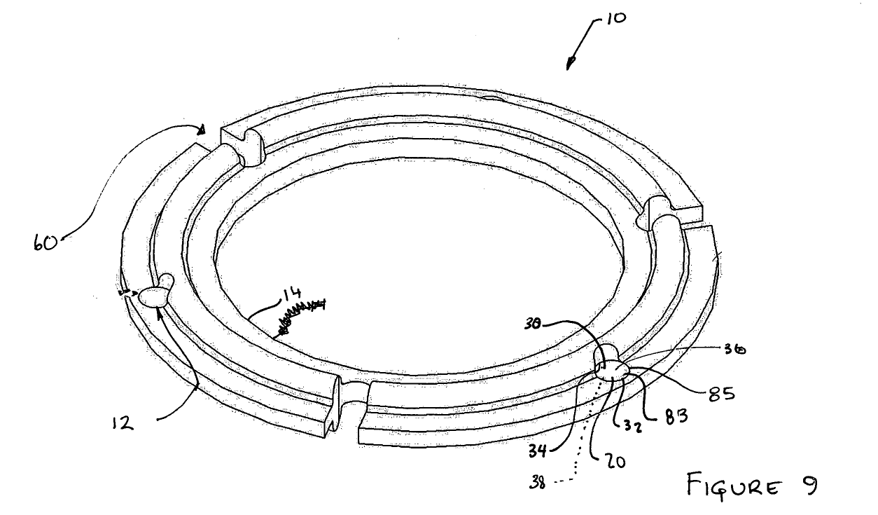

Referring now to the Figures, and in particular to FIG. 5, sanitary gasket 10 is shown as comprising spacing assembly 12 and gasket assembly 14. It will be understood that, in general, sanitary gasket 10 is configured for providing an interface for joining opposing pipes 100, 110 (FIGS. 7,8). Opposing pipe 100 includes ferrule faces 102, 104 and channel 106 defined therebetween. Opposing pipe 110 includes ferrule faces 112, 114 and channel 116 defined thereby. The pipes and the sanitary gasket are cooperatively retained by clamp 120 (FIG. 7,8). Such a combination of pipes and clamps is quite commonplace in the container filling industry for retaining clamps for the passage of fluid within the bores thereof. Of course, the sanitary gasket of the present invention is well suited for other applications as well.

Spacing assembly 12 is shown in FIG. 5 as comprising spacing member 20 and positioning member 22. Spacing member 20 includes body 30, defining outer edge 32, inner edge 34, top surface 36 and bottom surface 38. Positioning member 22 includes ferrule engaging member 39 which is associated with outer edge 32 of spacing member 20 and generally integrated (co-molded or adhered) with each other. Positioning member 22 may include a single ferrule engaging member 39 which extends partially or wholly about the outer of the ferrule faces (104, 114), or a plurality of discrete ferrule engaging members. It will be understood that the ferrule engaging member may extend outwardly from top surface 36 or from bottom surface 38. As such, the cross-sectional appearance of the positioning member at any given location may comprise an “I”, an “L” or a “T” configuration. Of course other configurations are likewise contemplated for use.

Generally, the positioning member facilitates the proper position of the spacing assembly relative to the pipes 100, 110 (i.e., the ferrules thereof). The positioning member provides the proper spacing between opposing ferrules of pipes 100, 110. Indeed, and as will be explained below, the spacing member comprises a material which is more rigid than the material from which the gasket assembly is formed. Preferably, the positioning member is substantially rigid and incapable of substantial compression. Among other materials, it is contemplated that the following materials may be utilized: metals, alloys thereof, hard rubber materials, composites, rigid polymers, Teflon, etc.

Gasket assembly 14 is shown in FIG. 5 as comprising gasket body 40 which defines bore interfacing edge 42, spacing assembly interfacing edge 44, upper surface 46 and lower surface 48. Upper surface 46 includes rib 49 which is configured to engage channel 106 between ferrule faces 102, 104 of pipe 100. Lower surface 48 includes rib 50 which is configured to engage channel 116 between ferrule faces 112, 114 of pipe 110. As the ferrules have a semi-circular or semi-oval configuration, the ribs have a substantially matching cross-sectional configuration. Of course, other configurations are likewise contemplated for use. The ribs may be positioned between the bore interfacing edge and the spacing assembly interfacing edge, or the ribs may have one end thereof coinciding with one of the opposing edges of the gasket assembly. It will be understood that the body of the gasket assembly may be thicker than that of portions of the spacing assembly such that compression of the gasket will compress the gasket member prior to engagement with the spacing assembly.

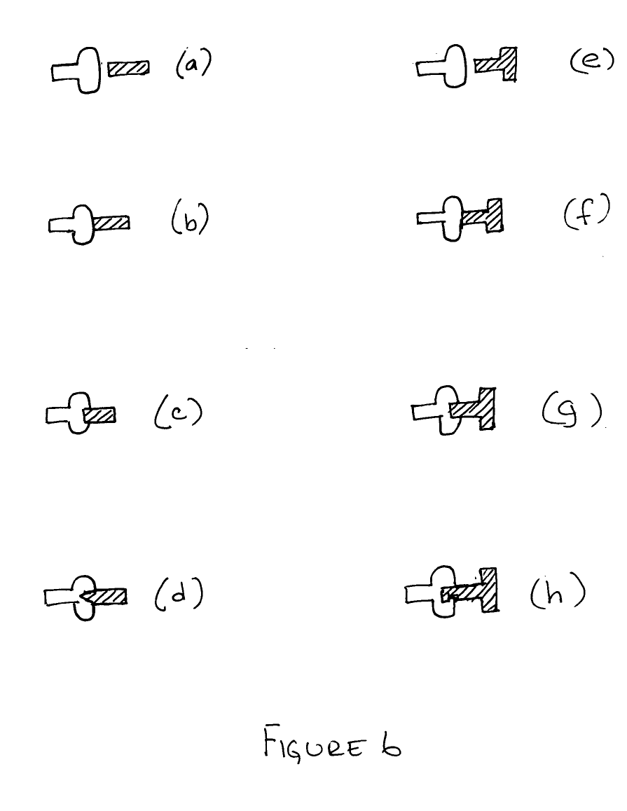

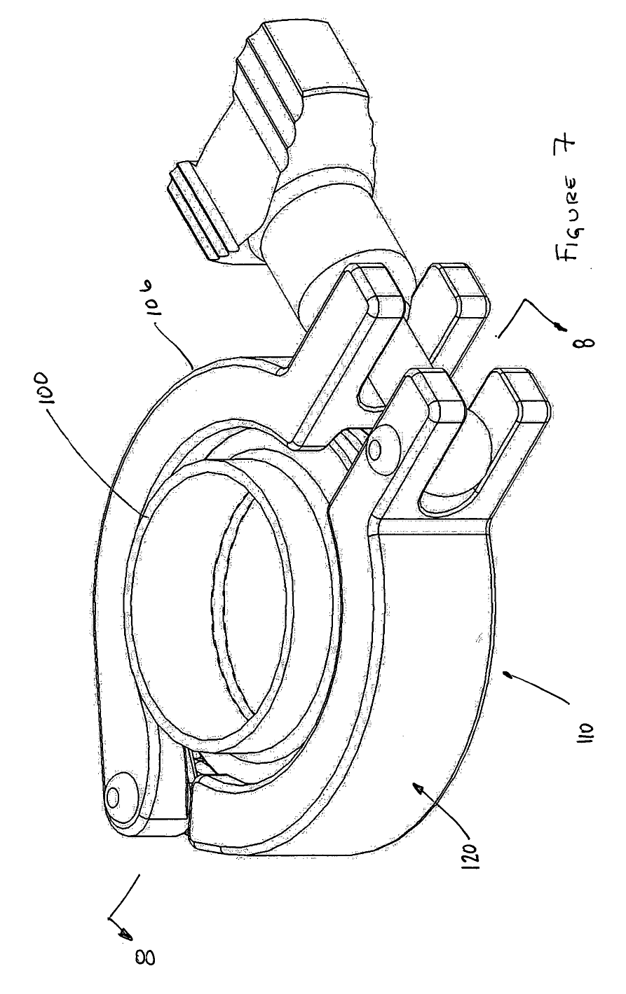

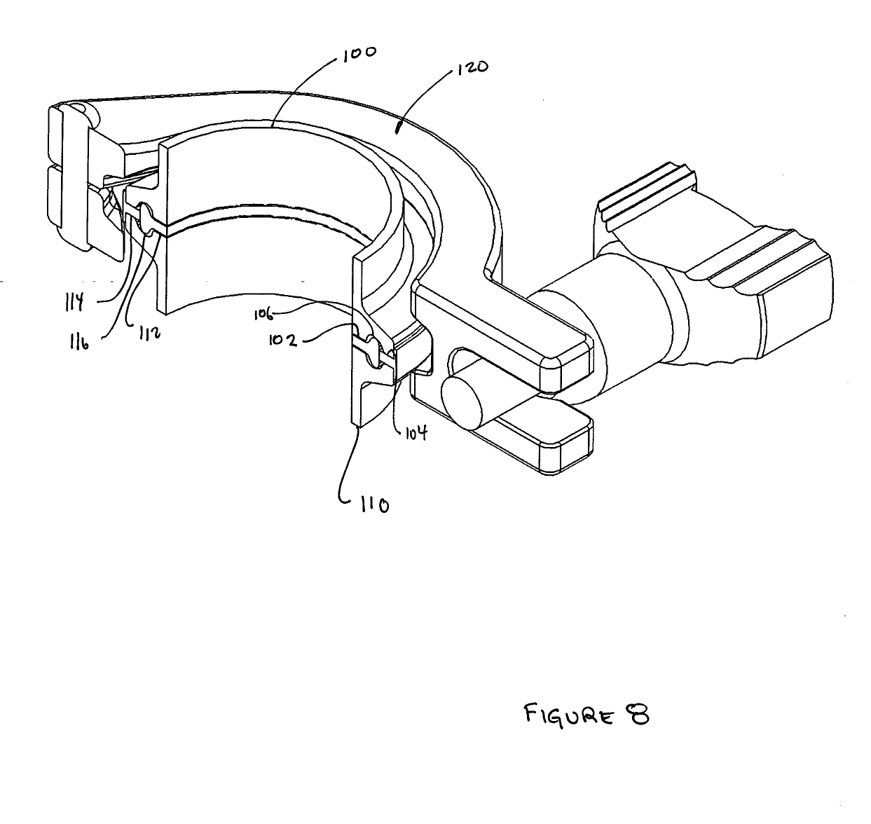

Spacing assembly interfacing edge 44 is configured to substantially associate with inner edge 34 of spacing member 20. In various embodiments, it is contemplated that the inner edge of the spacing member and the spacing assembly interfacing edge may be joined through adhesion, heat sealing, co-molding, mechanical attachment (i.e., slot and groove, snap fit, interference fit, etc.), among others. It is contemplated that such physical connection between the edges may be continuous about the circumference of the edges, or may be achieved at one or more discrete locations. Of course, in certain embodiments the two edges may be spaced apart from each other. It is preferred, while not required, that a positive and substantially strong connection be maintained between the spacing assembly and the gasket assembly such that the spacing assembly assists with retention of the gasket assembly in operation (even in conditions wherein a vacuum is present within the bore of pipes 100, 110). As such, the inner edge of the spacing member and the outer edge of the spacing assembly interfacing edge may overlap each other so as to extend into the body of the respective spacing assembly and gasket assembly for enhanced attachment properties. Various configurations are shown in FIGS. 6(a) through 6(h) wherein the spacing assembly and the gasket assembly are two separate components (FIGS. 6(a) and 6(e)), adhered or joined components (FIGS. 6(b) and 6(f)), mechanically fastened (FIGS. 6(c) and 6(g)) or integrally molded (FIGS. 6(d) and 6(h)).

In another embodiment of the invention, with reference to FIG. 9, the spacing member 20 may comprise a plurality of components 83 which are positioned at discrete locations about the gasket assembly 14. Spacing member 20 (i.e., each component 83) includes body 30, defining outer edge 32, inner edge 34, top surface 36 and bottom surface 38. For example, and as shown in FIG. 9, the components 83 may comprise plugs which are co-molded or otherwise interfaced with openings 85 which extend through the gasket assembly. The precise number of components utilized are not limited to any particular quantity, and, indeed, any number of spacing components can be utilized to effectively insure the proper compression of the gasket assembly.

In such a fashion, the size of the spacing member can be reduced, while insuring that a proper spacing of the gasket assembly is maintained. While circular plugs are shown in the Figure, it will be understood that a number of differently shaped components may be utilized. Moreover, it is not required that the plugs be entirely surrounded by the gasket assembly. For example, the outer edge of the spacing member may coincide with the outer edge of the gasket assembly. Furthermore, while the plugs are shown as being evenly spaced about the circumference of the gasket assembly, a number of different positions for the plugs are contemplated.

It will be understood that openings may be present within the gasket assembly at discrete and strategically important positions to provide for a leak detection system. Such a configuration is shown in FIG. 9, wherein openings 60 are positioned at discrete locations about the sanitary gasket. While various different configurations are contemplated, gasket assembly may comprise a soft rubber material, a silicone rubber, or other material which is preferably softer than the material from which spacing member is formed. Of course, copolymers or a combination of materials is likewise contemplated for use.

In operation, the user first grasps one of opposing pipes, namely pipe 100. Next, the user attaches sanitary gasket to pipe 100. Specifically, the user positions each of the spacing assembly and the gasket assembly in the proper configuration relative to ferrule faces 102, 104 and channel 106. Positioning member 22 cooperating with the ferrule assists with the proper orientation of spacing assembly 12. Similarly, rib 49 cooperates with channel 106 to insure proper positioning of the gasket assembly. It will be understood that wherein the spacing assembly and the gasket assembly comprise a single integrated member (or an integratable member), the two assemblies may be positioned simultaneously relative to pipe 100.

Once the sanitary gasket is positioned relative to pipe 100, pipe 110 is introduced to the opposing side of the sanitary gasket. As with the first pipe, the spacing assembly (with the aid of positioning member 22) and the gasket assembly (with the aid of rib 50) are positioned in the proper orientation. Once positioned, the user extends clamp 120 (FIGS. 7, 8) around the ferrules. Subsequent tightening of the clamp serves to sandwich the sanitary gasket with increasing force. With the present gasket, the spacing member is sized relative to the gasket assembly in such a manner that as the clamping force pinches the spacing member, the spacing member precludes further compression of the gasket. Advantageously, the spacing member is sized such that when the reasonable compression limit of the spacing member is reached (which may be zero compression for a substantially rigid gasket), the resulting compression yields a desired compression of gasket assembly 14, and, in turn, a desired seal between the pipe members, without an over compression of gasket assembly 14.

The foregoing description merely explains and illustrates the invention and the invention is not limited thereto except insofar as the appended claims are so limited, as those skilled in the art who have the disclosure before them will be able to make modifications without departing the scope of the invention.

1. A sanitary gasket for use between two pipes, each having a plurality of ferrule faces defining a channel thereon, the sanitary gasket comprising:
a spacing assembly, having a spacing member including a body having an inner edge and an outer edge; and
a gasket assembly having a spacing assembly interfacing edge associated with the inner edge of the spacing assembly,
wherein the gasket assembly is of a softer material than the spacing assembly, such that, upon clamping, the spacing assembly controls the spacing between two pipes, and, in turn, the compression of the gasket assembly.

2. The sanitary gasket of claim I wherein the spacing assembly further comprises a positioning member associated with the outer edge thereof, the positioning member having at least one ferrule engaging member.

3. The sanitary gasket of claim 2 wherein the at least one ferrule engaging member extends outwardly from one of a bottom surface and a top surface of the spacing member.

4. The sanitary gasket of claim 3 wherein the at least one ferrule engaging member extends outwardly from each of the bottom surface and the top surface of the spacing member.

5. The sanitary gasket of claim 2 wherein the at least one ferrule engaging member comprises a plurality of discrete ferrule engaging member positioned about the outer edge of the spacing member.

6. The sanitary gasket of claim 2 wherein the at least one ferrule engaging member extends continuously about the outer edge of the spacing member.

7. The sanitary gasket of claim 1 wherein the spacing assembly interfacing edge is spaced apart from the inner edge of the spacing member.

8. The sanitary gasket of claim 1 wherein the spacing assembly interfacing edge is mechanically attached to the inner edge of the spacing member.

9. The sanitary gasket of claim 1 wherein the spacing assembly interfacing edge and the inner edge of the spacing member are one of adhered and co-molded together.

10. The sanitary gasket of claim 1 wherein the spacing assembly interfacing edge and the inner edge of the spacing member overlap.

11. The sanitary gasket of claim 1 wherein the gasket assembly further includes a pair of opposing ribs which are configured so as to interface with an opposing channel in each of two pipes.

13. Combination pipe and gasket assembly comprising:
a first pipe having a ferrule face defining a channel thereon;
a second pipe having a ferrule face defining a channel thereon, wherein the ferrule faces of the first and second pipe, as well as the channels of the first and second pipes substantially correspond to each other;
a sanitary gasket positioned between the two pipes, the sanitary gasket comprising:
a spacing assembly, having a spacing member including a body having an inner edge and an outer edge;
a gasket assembly having a spacing assembly interfacing edge associated with the inner edge of the spacing assembly,
wherein the gasket assembly is of a softer material than the spacing assembly, such that, upon clamping, the spacing assembly controls the spacing between two pipes, and, in turn, the compression of the gasket assembly.

14. The sanitary gasket of claim 13 wherein the spacing assembly further comprises a positioning member associated with the outer edge thereof, the positioning member having at least one ferrule engaging member.

15. The sanitary gasket of claim 14 wherein the at least one ferrule engaging member extends outwardly from one of a bottom surface and a top surface of the spacing member.

16. The sanitary gasket of claim 15 wherein the at least one ferrule engaging member extends outwardly from each of the bottom surface and the top surface of the spacing member.

17. The sanitary gasket of claim 14 wherein the at least one ferrule engaging member comprises a plurality of discrete ferrule engaging member positioned about the outer edge of the spacing member.

18. The sanitary gasket of claim 14 wherein the at least one ferrule engaging member extends continuously about the outer edge of the spacing member.

19. The sanitary gasket of claim 13 wherein the spacing assembly interfacing edge is spaced apart from the inner edge of the spacing member.

20. The sanitary gasket of claim 13 wherein the spacing assembly interfacing edge is mechanically attached to the inner edge of the spacing member.

21. The sanitary gasket of claim 13 wherein the spacing assembly interfacing edge and the inner edge of the spacing member are one of adhered and co-molded together.

22. The sanitary gasket of claim 13 wherein the spacing assembly interfacing edge and the inner edge of the spacing member overlap.

23. The sanitary gasket of claim 13 wherein the gasket assembly further includes a pair of opposing ribs which are configured so as to interface with an opposing channel in each of two pipes.

24. The sanitary gasket of claim 13 wherein the gasket assembly may include at least one opening extending therethrough, to, in turn, provide for leak detection.

25. A sanitary gasket for use between two pipes, each having a ferrule face defining a channel thereon, the sanitary gasket comprising:
a spacing assembly, having a spacing member including a body having an inner edge, an outer edge, a top surface and a bottom surface; and
a gasket assembly having a spacing assembly interfacing edge, a bore interfacing edge, a top surface and a bottom surface, each of the top surface and the bottom surface including opposing ribs positioned thereon, the spacing assembly interfacing edge associated with the inner edge of the spacing assembly,
wherein the gasket assembly is of a softer material than the spacing assembly, such that, upon clamping, the spacing assembly controls the spacing between two pipes, and, in turn, the compression of the gasket assembly.

26. The sanitary gasket of claim 25 wherein the spacing assembly and the gasket assembly are integrated into a single component.

27. A sanitary gasket for use between two pipes, each having a ferrule face defining a channel thereon, the sanitary gasket comprising:
a gasket assembly having a bore interfacing edge, a top surface and a bottom surface, each of the top surface and the bottom surface including opposing ribs positioned thereon, the spacing assembly interfacing edge associated with the inner edge of the spacing assembly,
a spacing assembly comprising a plurality of plugs disposed about the gasket assembly, each of the plurality of plugs having a top surface and a bottom surface;
wherein the gasket assembly is of a softer material than the spacing assembly, such that, upon clamping, the spacing assembly controls the spacing between two pipes, and, in turn, the compression of the gasket assembly.

28. The sanitary gasket of claim 27 wherein the plurality of plugs are fully surrounded by the gasket assembly.

29. The sanitary gasket of claim 27 wherein the plurality of plugs are positioned at a predetermined distance from the bore interfacing edge of the gasket assembly.

30. The sanitary gasket of claim 27 wherein the plurality of plugs are substantially circular in shape.

31. The sanitary gasket of claim 27 wherein the plurality of plugs are positioned are substantially uniformly positioned about a circumference of the gasket assembly.
